(19) United States
(12) Patent Application Publication
(10) Pub. No.: US 2006/0106499 A1
(43) Pub. Date: May 18, 2006

(54) System and method for emergency shutdown of selected services and facilities in a multi-unit building

(76) Inventors: Philipp A. Roosli, Niantic, CT (US); Duane W. Buckingham, Old Lyme, CT (US)

Correspondence Address: CANTOR COLBURN, LLP, 55 GRIFFIN ROAD SOUTH, BLOOMFIELD, CT, 06002, US

(21) Appl. No.: 11/257,794

(22) Filed: Oct. 24, 2005

Related U.S. Application Data
(60) Provisional application No. 60/621,202, filed on Oct. 22, 2004.

(51) Int. Cl. G01M 1/38; G05B 13/00

(52) U.S. Cl. 700/276

(57) ABSTRACT

A method and system of shutting down services in rooms of a multi-unit building is provided. The method includes detecting a shutdown code, generating a command in response to the shutdown code, receiving the command at gateway devices associated with the rooms, transmitting the commands from the gateway devices, receiving the commands at room control devices associated with the rooms, and processing the command at the control devices to effect a shutdown of the services generated by room devices associated with the room control devices.

### CROSS REFERENCE TO RELATED APPLICATION

This application claims the benefit of U.S. Provisional Patent Application No. 60/621,202 filed on Oct. 22, 2004, the contents of which are herein incorporated by reference in their entirety.

### BACKGROUND OF THE INVENTION

Multi-unit buildings such as hotels, motels, inns, condominiums and the like, offer a variety of services and facilities for the convenience of their guests. Guest services typically include maid service, concierge services, in-room dining services, laundry and dry cleaning services, wake-up calls, shoeshine services, butler services, and others. Facilities available for control or access by a guest typically include Heating/Ventilation/Air-Conditioning (HVAC) control units or thermostats, mini-bar, room lighting, door locks, television, alarm clock, radio, telephone, internet access, electronic drapes, and others.

Many modem guest rooms include room control systems. Room control systems include a central control computer or device that receives data from various remote sensors and operates a number of remote room control devices. Such remote sensors include, for example, motion sensors, temperature sensors, smoke detectors, and door and other closure switches. Such remote room control devices include, for example, thermostats and associated relays for heating, ventilation and air conditioning (HVAC) equipment, electronic locks, lighting control switches and relays, and motors and switches for opening and closing drapes. The central control computer uses the data and control devices to, for example, adjust the room's temperature, determine and annunciate whether the room is occupied or unoccupied, determine and annunciate whether the room's mini-bar has been accessed, sound fire and emergency alarms, turn lights on or off, permit or deny access to the room, open and close drapes, turn audio-visual equipment on or off, and perform other functions related to controlling equipment or annunciating status in rooms. A central control computer or device may be located in each room, and all rooms are tied to a single master central control computer. Where a central control computer or device is used in each room, each such computer or device provides data to the master central control computer from which such data is disseminated to display and control terminals at housekeeping, front desk, security, engineering or any number of other locations in order to provide hotel personnel with access to the data and with the ability to remotely control various room functions or settings from such terminals.

Room control systems are valuable tools for the lodging industry. Unfortunately, the equipment and installation costs associated with room control systems are generally too expensive for most new construction and renovation projects.

### SUMMARY OF THE INVENTION

The above discussed and other drawbacks and deficiencies are overcome or alleviated by an exemplary method and system of shutting down services and/or facilities in rooms of a multi-unit building.

In on exemplary embodiment, the method includes: detecting a shutdown code; generating a command in response to shutdown code; receiving the command at gateway devices associated with the rooms; transmitting the command from the gateway devices; receiving the command at room environmental control devices associated with the rooms; and processing the command at the room environmental control devices to effect a shutdown of ventilation generated by room environmental devices associated with the room environmental control devices.

In another embodiment, the method includes inserting a card key into any of a plurality of electronic door locks of the multi-unit building, the card key including a shutdown code, detecting the shutdown code at the electronic lock and generating a signal in response, receiving the signal at a first gateway device associated with the electronic lock, transmitting the signal from the first gateway device to a central server of the multi-unit building, generating a shutdown command at the server and transmitting the command to gateway devices associated with the rooms of the multi-unit building, and effecting a shutdown of the service in the rooms of the multi-unit building in response to receiving the shutdown command at the gateway devices.

The system of the invention, in one exemplary embodiment, provides a key card including a shutdown command, electronic locks associated with the rooms of the multi-unit building and configured to read the shutdown code and further configured to transmit a signal in response to the shutdown code, gateway devices associated with the rooms and configured to receive the signal from the electronic locks and further configured to transmit the signal, a central server in communication with the gateway devices and configured to receive the signal and generate a shutdown command in response to the signal, wherein the shutdown command is disposed to effect a shutdown of the service in the rooms of the multi-unit building.

The above-discussed and other features and advantages of the present invention will be appreciated and understood by those skilled in the art from the following detailed description and drawings.

### BRIEF DESCRIPTION OF THE DRAWINGS

Referring now to the drawings wherein like elements are numbered alike in the several FIGURES:

FIG. 1 is a top sectional view of a room showing the installation of room control devices;

FIG. 2A is a front view of a gateway module of FIG. 1;

FIG. 2B is a front view of a transceiver module of FIG. 1;

FIG. 3 is a front perspective view of a light switch with the gateway module of FIG. 2A;

FIG. 4 is a schematic view of the light switch of FIG. 3; and

FIG. 5 is a centralized occupant room control system or network.

### DETAILED DESCRIPTION OF THE INVENTION

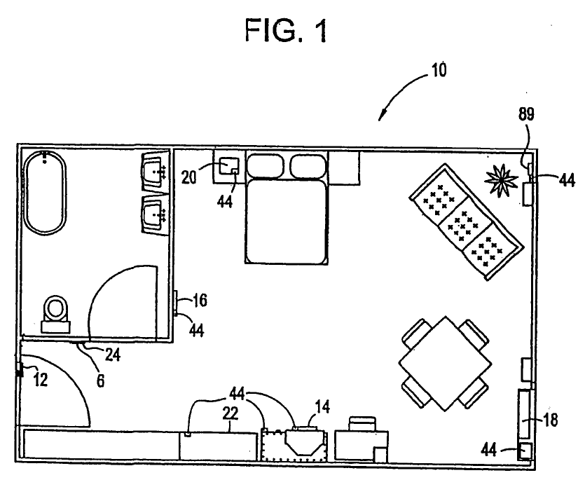

FIG. 1 shows an exemplary room 10 of a multi-unit building, the room including a number of room control devices enhancing the security and convenience of occupants, and the operating efficiency of the staff or the multi-unit building. Multi-unit building includes hotels, motels, inns, dormitories, cooperatives, apartments, condominiums, and the like, that offer a variety of services and facilities for the convenience of their guests or residents (occupants). A gateway module 6 that includes a transceiver is provided within the room. The gateway module communicates with other room control devices. For example, room control devices include a door lock (a Central Electronic Lock System (CELS) device) 12, a television set box top 14, a thermostat 16, and/or a heating/air conditioning unit 18, a telephone 20 and a mini-bar 22, each including electronic controls and a transceiver module 44 allowing one- or two-way communication with the gateway module 6.

Heating/air conditioning units 18 may include a Fan Coil Unit (FCU), a Packaged Terminal Air Conditioner (PTAC) or other Heating, Ventilation, and Air Conditioning (HVAC) system. Room control devices may also include an Energy Management System (EMS) device, a Direct Digital Control (DDC) system device, and other electronic devices typically found in rooms or units of a multi-unit building. A Packaged Terminal Air Conditioner (PTAC) is an air conditioner/heater unit that extends through an exterior wall of the building. The Fan Coil Unit (FCU) controls ventilation for heating and cooling the room. An Energy Management System (EMS) device is a component in a system that digitally controls a heating, ventilation, and/or air conditioning system associated with the room and which may include a digitally controlled thermostat. One example of an EMS is the e⁴™ Energy Management System commercially available from Inncom International, Inc. of Niantic, Conn. A direct digital control (DDC) system device is a component in a system that allows an occupant to remotely control devices or appliances.

A central electronic lock system (CELS) device is a component in a system for locking and unlocking an access door to the room. CELS devices may include, for example, a model K594 Infrared Transceiver, which is commercially available from Inncom International, Inc., and infrared capable room door locks commercially available from such companies as TimeLox, Sargent, Safelok, and VingCard. These electronic lock systems utilize a key card which typically have a magnetic strip, as is well known.

Any of these devices may be controlled or queried remotely via access to the local area network utilizing wired or wireless communication. In a preferred embodiment module transceiver 44 provides for wireless (e.g., IR (infrared) or RF (radio frequency)) communication. With IR communication diffuse infrared dispersion is utilized to allow the transceivers to communicate around corners within the room such that the devices need not be in each other's line of sight, as exemplified in FIG. 1. Gateway module 6 may be incorporated into any one of the aforementioned devices or may be a standalone device located within the room.

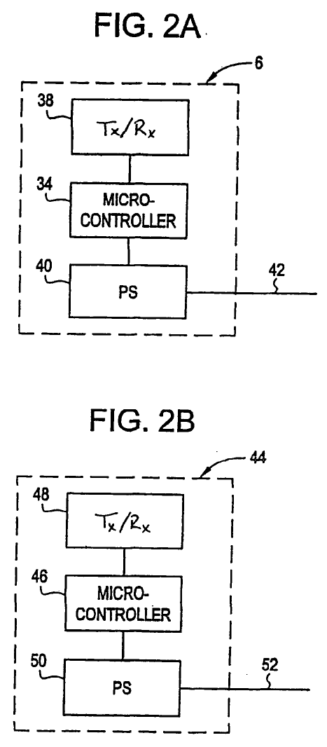

Referring to FIG. 2A, gateway module 6 includes a microcontroller 34 having associated memory, i.e., random access memory (working memory) and non-volatile memory (boot-code and programming instructions) and an interface for providing data communication with a central floor switch 520 (FIG. 5). A transceiver 38 is connected to microcontroller 34 for providing communication. Gateway module 6 is powered by a power regulator or supply 40 connected to line power 42, although gateway module 6 may be directly powered from an appropriate low voltage line (whereby the power regulator 40 could be eliminated). While a microcontroller is described as having integrated elements, it will be appreciated that the memory and interface could be discrete elements, as is well known in the art. Also, microcontroller may alternatively comprise a microprocessor, a programmable logic device (PLD), a programmable logic array (PLA), a programmable logic controller (PLC) or other suitable device, each being well known in the art and the configuration of each being readily apparent to one skilled in the art.

Gateway module 6 communicates over the LAN in a suitable protocol (e.g., TCP/IP, UDP/IP, or RF MESH-NET). Gateway module 6 communicates with other room control devices, in this exemplary embodiment, via infrared communication in a suitable protocol that is compatible with the room control devices. For example, the infrared communication protocol described in U.S. Pat. No. 5,128,792, which is incorporated herein by reference, may be utilized. Digital iterative gain control such as described in U.S. patent application Ser. No. 10/631,457, entitled Digital Iterative Gain Control, filed Jul. 30, 2003, which is incorporated herein by reference, may also be utilized. Further, the infrared communication protocol may be the IR5 infrared protocol described in the above-referenced applications. Other infrared communication protocols may include IRDA, or the like. The gateway module 6 may alternatively communicate with the other room control devices via wireless RF communication, for example, 802.11b radio frequency protocol, WI-FI, Bluetooth®, 802.15.4, or any other suitable wireless protocol. It will be appreciated that gateway module 6 may be incorporated in any or all of the room control devices described above.

FIG. 2B illustrates transceiver module 44, which can also be used in each of the room control devices. Module 44 is similar to the gateway module (FIG. 2A), except that module 44 is not directly connected to a control system or network 500 (FIG. 5). Module 44 communicates with gateway module 6, which is connected to system 500. Module 44 includes a microcontroller 46 having associated memory, i.e., random access memory and non-volatile memory and an interface for providing data communication with the device itself, in a protocol compatible with the device. A transceiver (and/or transmitter) 48 is connected to microcontroller 46 for proving infrared communication with gateway module 6 via infrared communication in a suitable protocol that is compatible therewith. Power is provided by a power regulator or supply 50 connected to line power 52 or an appropriate low voltage line (whereby the power regulator 50 could be eliminated). In addition, power supply could also contemplate a battery. The infrared communication protocol may be any suitable infrared protocol such as described hereinbefore.

In order to reduce the costs of wiring, typically, only one of the room control devices acts as gateway module 6 in the room. Because modules 44 do not need to be wired to system 500 (FIG. 5), it is more economical to place modules 44 on each of the room control devices. The room control device that is physically located in the most convenient location is gateway module 6 and is wired to the network while the remaining room control devices with modules 44 communicate via the gateway module 6.

Referring again to FIG. 1, light switch 24 is identified, in the exemplary embodiment, as the most convenient location to wiring (not shown) extending behind the wall at the main entrance to the room. However, such wiring may instead be extended to the interior of the room with the gateway being incorporated in any one of the other room control devices. Also, in retrofitting older buildings the wiring could be extended on the exterior of the building, and in that case, the PTAC may be the most convenient room control device to act as the room gateway. Another possible alternative in retrofitting would be to extend the wiring along ventilation ducts behind the thermostat. The wiring scheme will be dictated by the existing structure or the design of a new (or remolded) structure. In yet another embodiment, the interface for the gateway module 6 is a wireless interface that communicates with a wireless switch (central floor switch 520, FIG. 5), such wireless networks being well known.

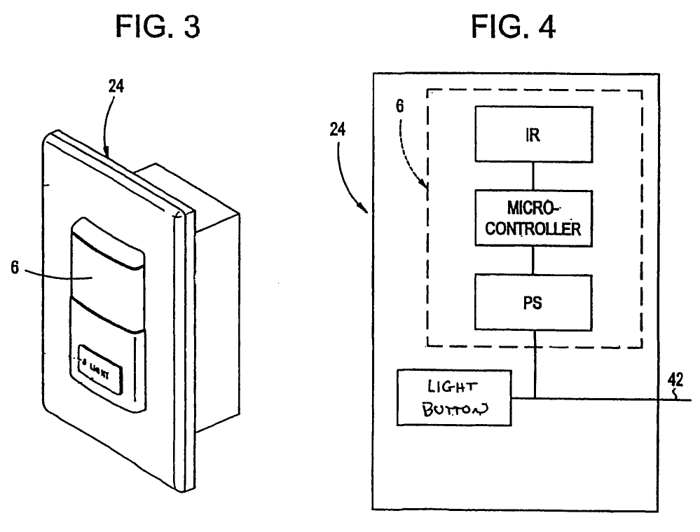

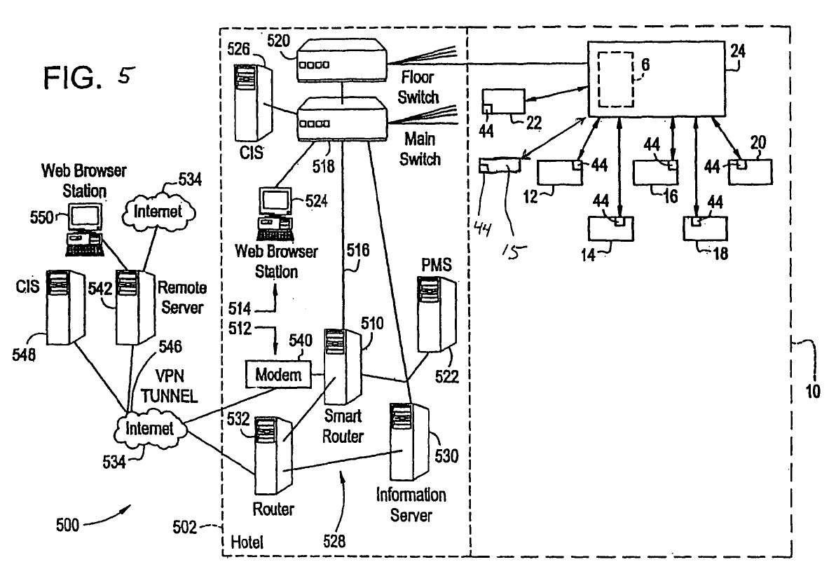

Referring to FIGS. 3 and 4, and exemplary embodiment of the invention illustrates gateway module 6 being incorporated into light switch 24. Gateway module 6 is connected to a central switch for the floor or area where the room is located by wiring, (e.g., twisted-pair not shown), i.e., to a Local Area Network (LAN). Alternatively, the gateway could be connected to electrical or telephone wiring for providing communication over such, as communication on such wiring is known.

FIGS. 1 and 2B also illustrate a television set top box 14 and telephone 20 with modules 44. These locations would also serve as good locations for gateway modules 6 because both the television set top box 14 and telephone 20 are hardwired. Thermostat 16 and/or heating and air conditioning unit 18 may also include module 44. When an occupant adjusts the temperature, that information can be transmitted to system 500 (FIG. 5).

FIG. 5 depicts a centralized room control system or network 500 of the type described in International Application Serial No. PCT/JUS02/02354, filed on Jan. 24, 2002, entitled Smart Router for a Guest Room Service and Control System, which is incorporated herein by reference. Building-level services such as, but not limited to, central electronic lock control, energy management, room control, and Internet access services are provided to one or more rooms 10 throughout one or more hotels 502 (or other multi-unit building) over the same network. While the present example is directed to one or more hotels 502, it will be recognized that the system 500 has application in a wide range of multi-unit buildings including, but not limited to, universities, health care, multi-dwelling units (MDUs), office, resort, and residential.

Room control system 500 is distributed across three general areas: one or more rooms 10, hotel 502 including the one or more rooms 10, and a location external to the hotel 502. It will be appreciated that the room control system 500 can be distributed across any number of rooms 10 in the hotel 502 and any number of buildings or hotels 502.

Inside hotel 502, room control system 500 is divided by a smart router 510 into two sub-networks: a primary network 512 and a secondary network 514. Secondary network 514 includes a local area network (LAN) 516 employing the Ethernet protocol for transferring data encapsulated in packets. LAN 516 includes a main switch 518 that filters and forwards packets between one or more floor switches 520. Floor switches 520 filter and forward packets to rooms 10 on a floor of hotel 502.

Secondary network 514 includes a commercially available property management system (PMS) server 522 connected serially or via the Ethernet to smart router 510. PMS server 522 may include, for example, the Micros® Fidelio OPERA PMS, which is commercially available from Micros Systems, Inc. of Columbia, Md. PMS server 522 stores, processes, and recalls room usage information (i.e., whether the room is rented or vacant) and room billing information for lodging fees, Internet access, video-on-demand, mini-bar usage and other services. PMS server 522 transmits room status information to and accepts billing information from smart router 510.

Secondary network 514 also includes a web browser station 524, which is a personal computer connected to a port of main switch 518. Web browser station 524 allows hotel personnel to access hotel information. The station 524 uses a browser to provide indication on rented status, room occupancy, minibar service, do-not-disturb (DND) and make-up-room (MUR) requests, diagnostics and other data. Engineering or management personnel will be able to see information on energy management performance, diagnostic alerts and other useful items. A central interface server (CIS) 526 is also provided, which stores, processes, and recalls room control signals to augment on-site capability. One example of a CIS 526 is Inncom International's commercially available CIS-5 22058 Central Interface Server.

Primary network 512 includes a LAN 528 employing the Ethernet protocol for transferring data encapsulated in packets. LAN 528 includes one or more information servers 530 and a router 532. Information servers 530 store, process, and retrieve data typically used in the operation of a modern hotel system.

Router 532 connects primary network 512 with the Internet 534. Router 532 receives TCP/IP packets from the Internet 534 and uses packet headers and a forwarding table stored within router 532 to direct the packets to smart router 510 or information server 530. Router 532 also provides firewall and security services for the primary and secondary networks 512, 514. In addition to router 532, a modem 540 connects primary network 512 with the Internet 534 via smart router 510, and smart router 510 provides a firewall and security services for the primary and secondary networks 512, 514.

Outside hotel 502, all hotel data, including the hotel's in-house Internet homepage, are stored and maintained on a remote server 542. Remote server 542 is connected to the Internet 534, and a connection between the remote server 542 and router 532 in hotel 502 is maintained via a Virtual Private Network (VPN) Tunnel 546. All Internet traffic coming from router 532 or modem 540 in hotel 502 is automatically directed to remote server 542 through Virtual Private Network (VPN) 546. A CIS 548 is located outside hotel 502 and communicates with primary system 512 via VPN 546 and router 532. By placing CIS 548 at a remote site, CIS 548 can store, process, and recall control signals for legacy room control systems in any number of hotels 502. The remote CIS 548 can replace or supplement information server 530 in hotel 502.

Because all Internet traffic to and from hotel 502 traverses VPN 546 to remote server 542, remote server 542 can act as a portal for internet traffic.

Smart router 510 periodically connects through modem 540 and VPN 546 to the remote server 542. Through these connections, smart router 510 off-loads collected hotel and occupant information to the remote server 542. This information can be monitored using a web browser station 550 connected with the remote server 542. In addition, remote server 542 provides this information back to the hotel 502, via router 532 and VPN 546, where the information can be viewed through browser station 550. In this manner, a single user can view the status of any number of hotels 502 or hotel rooms 10 from a single location (e.g., browser station 524 or browser station 550).

Communication between smart router 510 and the room control devices, i.e., door lock 12, television set box top 14, thermostat 16, and/or a heating/air conditioning unit 18, telephone 20, and mini-bar 22, via gateway module 6 is performed using a series of query and reply frames (packets) using UDP as the link protocol. Each frame includes a frame header containing addressing information for a specific room gateway module 6 and a specific room control device, a frame sequence number, a control flag that can disable a reply to the frame, and a field that defines the type of the frame (e.g., query by smart router 510, query by room gateway module 6, response by smart router 510, or response by room gateway module 6).

By way of example, smart router 510 can off-load data to room control device via gateway module 6 by using a series of query frames with their control flags set to disable any reply. For a more detailed explanation of this process, please see International Application Serial No. PCT/US02/02354, filed on Jan. 24, 2002, entitled Smart Router for a Guest Room Service and Control System.

Remote server 542 also connects with smart router 510 to upload data from remote server 542 to smart router 510. Smart router 510 will then direct the data to the PMS server 522 or to the appropriate floor, room, and appliance. In this manner, a single user can alter the state of the PMS or any appliance in any room from a remote location.

Where smart router 510 requires a reply from one of the room control devices, smart router 510 can query the room control via room gateway module 6 using one or more frames having their control flags set to enable a response. Upon receiving these frames, room gateway module 6 will strip the header from the frame and send the data to the appropriate room control device. Room gateway module 6 saves the frame sequence number in anticipation of the response. Upon response from the room control device, room gateway module 6 encapsulates the response data within a frame and includes the frame sequence number in the appropriate field. Upon receiving the frame, smart router 102 identifies the response using the frame sequence number and processes the response data from the frame.

The room control device may be configured to provide an event message in response to some event within room 10. An event message may include the opening of a door to a minibar or operation of a door lock by someone in room 10, for example. Upon receiving such an event message, room gateway module 6 encapsulates the event message into one or more frames. Each frame includes addressing information from the room control device. Room gateway module 6 sends the frames to smart router 510, which uses the addressing information to determine the origin and appropriate response to the event message.

Smart router 510 is discussed in greater detail in International Application Serial No. PCT/US02/02354, filed on Jan. 24, 2002, entitled Smart Router for a Guest Room Service and Control System, which has been incorporated herein by reference, and reference should be made thereto for a more detailed description of smart router 510.

Also as described in International Application Serial No. PCT/US02/02354, filed on Jan. 24, 2002, entitled Smart Router for a Guest Room Service and Control System, which has been incorporated herein by reference, data communication between LAN 528 or modem 540 and LAN 516 or PMS 522 is accomplished at the application levels of primary and secondary network processing systems. That is, data communication therebetween is handled by applications programs.

In accordance with an exemplary embodiment of the present invention selected key cards are encoded to generate an emergency shutdown command for selected services and facilities in the multi-unit building. Such an emergency may be the existence or potential exposure to smoke or airborne biological or chemical agents. These selected key cards are carefully controlled so that building management constantly knows who has such cards. These cards can be inserted into any electronic door lock (CELS device) 12 in the building, where they are read and an emergency shutdown command is generated. This command is then transmitted (wired or wirelessly) from the electronic door lock 12 to a gateway module 6 (in communication with electronic door lock 12, e.g., within the room associated with electronic door lock 12), where it is then communicated to the server. The server then generates preprogrammed shutdown commands, e.g., shutdown ventilation, close drapes, and to shutdown or suspend other services and facilities. The server then sends a command to a building or central ventilation (heating/air conditioning) system to shutdown. Further, the server sends a command to the gateway modules 6 in the building, which conveys (wired or wirelessly) a command to individual ventilation (heating/air conditioning) systems 18 to shutdown. The server may also send a command to the main (building) ventilation (heating/air conditioning) system to shutdown. Further, the server may also send a command to the gateway modules 6 in the building, which conveys (wired or wirelessly) a command to individual DDC devices to close drapes.

This shutdown preferably overrides individual device controls available to the occupants or guest. Alternatively, the server could periodically reissue these commands until the emergency or threat has abated.

Above, key cards are described by way of example as providing the shutdown command to the emergency shutdowns system of the invention. Such key cards may be magnetic stripe cards, proximity cards, IC cards (i.e., smart cards), etc. Of course, the broad scope of the invention contemplates other means and modes of delivering the shutdown code to the system. For example, a building manager or superintendent may enter the shutdown code directly into a building control device or control panel which then automatically initiates shutdown of the desired services and/or facilities as discussed above. Such control device or control panel may include an emergency shutdown button, switch, etc. for the purpose of sending the emergency shutdown command. Alternatively, the shutdown command may be initiated by telephone. For example, a certain telephone number may be dialed to a secure line which, upon receipt of the call, communicates the shutdown command to the server. Alternatively and/or additionally, the call may be made and then a unique code entered by way of the telephone key pad in order to send the command. In another example, a wireless hand held device may be used to generate the shutdown command. A personal digital assistant (PDA) or a wireless communication device, as for example that produced under the trade name, Blackberry®, may be used to send the shutdown command. Again, a unique code may be required to send the command to the server and to thus begin the shutdown procedure. In another example, a handheld wireless device may be specifically devoted to the emergency shutdown system of the multi-unit building. A building may have several such devices associated therewith. The device may be carried by building management, personnel, etc. Such device may simply include an actuator (button, switch, etc.) for sending the shutdown command or the device may require entry of a unique code, as described above. In any event, the shutdown command is transmitted to the server in case of an emergency. As described above, the server than begins the shutdown procedure.

As mentioned above, a unique code may be required in order to generate the shutdown code in accordance with the invention. Additionally and/or alternatively, a means may be employed for identifying the person or the credentials of the person sending the shutdown code. For example, voice, fingerprint, and/or retinal recognition systems may be utilized for sending the command. That is, some or all of these recognition systems may be employed to identify a person attempting to send the shutdown command. Once the recognition system identifies the person as being of proper identification and/or authority, the shutdown command may be sent and the shutdown procedure commenced.

In another embodiment of the invention, the emergency shutdown system is further configured to communicate with occupants of the multi-unit building with respect to the emergency shutdown. For example, the room 10 of FIG. 5 may include an additional room device 15 which is disposed in communication with the gateway module 6 by way of an additional transceiver module 44. The room device 15, in one embodiment, comprises emergency lighting which is illuminated when the gateway device 6 sends the shutdown command to the various room devices 12, 14, 16, etc. In another embodiment, the room device 15 may comprise an audible device which provides an audible signal upon receipt of the shutdown command in order to alert the room occupant. The device 15 may further be configured to provide audibly voiced information and/or instructions, in either pre-recorded or real-time formats. Such device may communicate the commencement of the shutdown, the nature of the emergency situation related to the shutdown, or may provide instructions concerning the emergency response, evacuation, etc. In this regard, the set top box 14 may additionally and/or alternatively be configured to respond in receipt of the shutdown command. That is, when the transceiver 44 of the set top box 14 receives the shutdown command, the set top box 14 may be configured to display a pre-programmed image or images on the television intended to alert, instruct, or inform the occupants regarding the shutdown and/or the emergency situation warranting the shutdown. Alternatively, upon receipt of the shutdown command, the set top box 14 may automatically tune the television to a certain channel at which emergency information or instruction may be broadcast by the multi-unit building (e.g., on a closed circuit channel) or by an outside network or by emergency personnel, etc. Of course, the invention contemplates employing any mode of in-room or outer-room communication to alert, instruct, and/or inform the occupants of the multi-unit building with respect to shutdown and the related emergency situation.

It will be understood that a person skilled in the art may make modifications to the preferred embodiment shown herein within the scope and intent of the claims. While the present invention has been described as carried out in a specific embodiment thereof, it is not intended to be limited thereby but is intended to cover the invention broadly within the scope and spirit of the claims.

1. A method of shutting down ventilation in rooms of a multi-unit building, comprising:
detecting a shutdown code;
generating a command in response to the shutdown code;
receiving the command at gateway devices associated with the rooms;
transmitting the commands from the gateway devices;
receiving the commands at room environmental control devices associated with the rooms; and
processing the command at the room environmental control devices to effect a shutdown of ventilation generated by room environmental devices associated with the room environmental control devices.

2. The method of claim 1, wherein said detecting the shutdown code comprises reading the shutdown code from a key card at an electronic door lock.

3. The method of claim 2, wherein said detecting the shutdown code further comprises transmitting the shutdown code from the electronic lock to one of the gateway devices and transmitting the shutdown code from one of the gateway devices to a server.

4. The method of claim 3, wherein said generating the command in response to the shutdown code comprises generating the command at the server and transmitting the command to the gateway devices.

5. The method of claim 1, further comprising receiving the command at a central ventilation controller and processing the command at the central ventilation controller to effect a shutdown of a main ventilation system of the multi-unit building.

6. The method of claim 1, further comprising receiving the commands at in-room communication devices and alerting in-room occupants of the shutdown by way of the in-room communication devices.

7. A method of shutting down a service in rooms of a multi-unit building, comprising:
inserting a card key into any of a plurality of electronic door locks of the multi-unit building, the card key including a shutdown code;
detecting the shutdown code at the electronic lock and generating a signal in response;
receiving the signal at a first gateway device associated with the electronic lock;
transmitting the signal from the first gateway device to a central server of the multi-unit building;
generating a shutdown command at the server and transmitting the command to gateway devices associated with the rooms of the multi-unit building; and
effecting a shutdown of the service in the rooms of the multi-unit building in response to receiving the shutdown command at the gateway devices.

8. The method of claim 7, wherein said effecting the shutdown comprises:
transmitting the shutdown command from the gateway devices to control devices associated with the rooms and associated with operation of the service; and
processing the shutdown command at the control devices to shutdown the service.

9. The method of claim 7, wherein said service comprises at least one of room environmental controls, television, internet, and open window treatments.

10. The method of claim 8, further comprising transmitting the shutdown command from the gateway devices to in-room communication devices and alerting in-room occupants of the shutdown by way of the in-room communication devices.

11. The method of claim 7, further comprising the server transmitting a signal external to the multi-unit building in response to the shutdown command.

12. The method of claim 11, wherein the external signal is transmitted in response to the shutdown command by a router to the internet, to other multi-unit buildings, or to emergency response personnel.

13. The method of claim 7, wherein, in response to receiving the signal from the gateway device, the central server generates a building-wide shutdown command for effecting the shutdown of the service throughout the multi-unit building.

14. A system for shutting down a service in rooms of a multi-unit building, the system comprising:
a key card including a shutdown command;
electronic locks associated with the rooms of the multi-unit building and configured to read the shutdown code and further configured to transmit a signal in response to the shutdown code;
gateway devices associated with the rooms and configured to receive the signal from the electronic locks and further configured to transmit the signal;
a central server in communication with the gateway devices and configured to receive the signal and generate a shutdown command in response to the signal;
wherein the gateway devices are disposed to effect a shutdown of the service in the rooms of the multi-unit building in response to the shutdown command.

15. The system of claim 14, further comprising service control devices associated with the rooms of the multi-unit building, wherein the server is configured to send the shutdown command to the gateway devices for transmission to the service control devices, wherein the service control devices are configured to process the shutdown command to effect the shutdown of the service.

16. The system of claim 14, wherein the server is further configured to send a building-wide shutdown command in response to the signal to effect the shutdown of the service throughout the multi-unit building.

17. The system of claim 14, wherein the service comprises at least one of room environmental controls, television, internet, and open window treatments.

18. The system of claim 16, wherein the room environmental controls comprise at least one of a Fan Coil Unit, a Heating Ventilation and Air Conditioning system, a Packaged Terminal Air Conditioner, and an Energy Management System.

19. The system of claim 14, further comprising communication devices disposed in the rooms of the multi-unit building in communication with the gateway devices, wherein the gateway devices are configured to send a shutdown command to the communication devices, and wherein, in response to the shutdown command, the communication devices alert in-room occupants of the shutdown.

20. The system of claim 14, wherein the service comprises air ventilation within the rooms of the multi-unit building, the system further comprising energy management control devices disposed in the rooms, wherein the gateway devices are disposed to transmit the shutdown command to the energy management control devices which are configured to process the command and effect a shutdown of the room ventilation.
